(19) United States
(12) Patent Application Publication
(10) Pub. No.: US 2023/0022436 A1
(43) Pub. Date: Jan. 26, 2023

(54) FORWARD FACING REAR VEHICLE VIDEO SYSTEM

(71) Applicant: Indiev, Inc, Los Angeles, CA (US)

(72) Inventors: Andre Hudson, Los Angeles, CA (US); Young Joon Ju, Los Angeles, CA (US)

(21) Appl. No.: 17/381,623

(22) Filed: Jul. 21, 2021

(51) Int. Cl. B60R 1/00; B60R 11/04; B60K 35/00; G06K 9/00

(52) U.S. Cl. CPC B60R 1/00; B60R 11/04; B60K 35/00; G06K 9/00838; B60R 2011/0026

(57) ABSTRACT

Systems and methods for viewing, observing, and/or monitoring a second row of seats in a vehicle are provided. A camera can be disposed in the second row of seats, near the rear of the vehicle, and can be forward-facing or generally forward-facing. The camera can provide a live video feed to a display located on the instrument panel in the front row of the vehicle.

### BACKGROUND

Safety regulations in the United States require children to be seated in the second row of a multi-row vehicle. If under a certain weight limit, a child is not only required to be in the second row but also to be in a rear-facing child seat. This makes it difficult or even impossible for the driver or a passenger in the front row of the vehicle to observe the child's face and overall status. Mirrors are often positioned on a rear seat headrest to enable a driver or front-row passenger to see a rear-facing child in the second row by turning back and looking at the mirror.

### BRIEF SUMMARY

In view of the above, there is a need in the art for an improved system for observing and/or monitoring a child in a rear-facing child seat in the second row of a vehicle. When using a mirror positioned on a rear seat headrest, the image is a reflection and is generally quite small. In addition, this requires the driver or front-row passenger to turn around and face away from the front windshield (or adjust the rear-view mirror attached to the front windshield), which can be dangerous for a driver and inconvenient for a driver and/or front-row passenger. This latter disadvantage of having to turn around and face away from the front windshield applies when viewing the second row of seats for any purpose, not just when there is a child in a rear-facing child seat (e.g., when viewing the second row to observe and/or monitor a child in a front-facing child seat or simply in the regular vehicle seat, and/or when conversing with a passenger in the second row, and/or when simply viewing the second row to check on the presence and/or position of one or more objects that may be in the second row of seats).

Embodiments of the subject invention provide novel and advantageous systems and methods for viewing, observing, and/or monitoring a second row (of seats) in a vehicle. A camera can be provided in the second row of seats, near the rear of the vehicle, and can be forward-facing or generally forward-facing. The camera can provide a live video feed (and/or still images) to a display in the vehicle, such as a display on the instrument panel in the front row of the vehicle. Such a display is easily viewable by a driver and/or a passenger in the front row. The live video feed (and/or still images) from the camera can be of the second row of seats and/or can be from a position looking forward and down on the back seat. This can enable a driver and/or a passenger in the front row to easily and conveniently observe and/or monitor the second row of seats (e.g., a rear-facing child in the second row of seats) without having to turn around and without the need for any mirror (attached to the front windshield or positioned on the rear seat headrest). For example, a driver and/or a passenger in the front row can easily and conveniently observe and/or monitor a child in a rear-facing child seat in the second row of seats. The system can allow such observation and/or monitoring whether the vehicle is stationary or in motion.

In an embodiment, a vehicle can comprise: a front row; a second row behind the front row; a camera disposed in or above the second row of the vehicle and facing towards the front row of the vehicle; and a display disposed in the front row of the vehicle and in operable communication with the camera, the display being configured to display a live video feed of the second row from the camera when in use. The vehicle can be a roadworthy vehicle, and the vehicle can be an electric vehicle. The vehicle can further comprise at least one light disposed on or adjacent the camera, the at least one light being configured to provide light to the second row when in use. The camera can be mounted on a rear header of the vehicle. The display can be disposed on an instrument panel of the vehicle. A direction in which the camera is pointed can be alterable by a user of the vehicle by using the display. A field of view of the camera can be alterable by a user of the vehicle by using the display. The display can be a central interactive display and can also be used for an infotainment system of the vehicle. The vehicle can further comprise a vehicle-integrated computer, wherein the camera and the display are in operable communication with the vehicle-integrated computer. The vehicle-integrated computer can operate an infotainment system of the vehicle. The vehicle can further comprise: a dashboard area; a front storage area forward of the dashboard area; and a compartment adjacent to or contained in the front storage area, and the vehicle-integrated computer can be disposed in the compartment.

In another embodiment, a system for viewing a second row in a roadworthy vehicle can comprise: a camera disposed in or above the second row of the vehicle having a front row and the second row, the camera facing towards the front row of the vehicle; and a display disposed in the front row of the vehicle and in operable communication with the camera, the display being configured to display a live video feed of the second row from the camera when in use. The vehicle can be an electric vehicle. The system can further comprise at least one light disposed on or adjacent the camera, the at least one light being configured to provide light to the second row when in use. The camera can be mounted on a rear header of the vehicle. The display can be disposed on an instrument panel of the vehicle. A direction in which the camera is pointed can be alterable by a user of the system by using the display. A field of view of the camera can be alterable by a user of the system by using the display. The display can be a central interactive display; the display can also be used for an infotainment system of the vehicle; the camera and the display can be in operable communication with a vehicle-integrated computer of the vehicle; and/or the vehicle-integrated computer can operate the infotainment system of the vehicle.

In another embodiment, a roadworthy electric vehicle can comprise: a front row; a second row behind the front row; a camera disposed in or above the second row of the vehicle and facing towards the front row of the vehicle; a display disposed in the front row of the vehicle and in operable communication with the camera, the display being configured to display a live video feed of the second row from the camera when in use; at least one light disposed on or adjacent the camera, the at least one light being configured to provide light to the second row when in use; a vehicle-integrated computer, wherein the camera and the display are in operable communication with the vehicle-integrated computer; a dashboard area; a front storage area forward of the dashboard area; and a compartment adjacent to or contained in the front storage area. The vehicle-integrated computer can be disposed in the compartment; the camera can be mounted on a rear header of the vehicle; the display can be disposed on an instrument panel of the vehicle, which is located at the dashboard area of the vehicle; a direction in which the camera is pointed can be alterable by a user of the vehicle by using the display; a field of view of the camera can be alterable by the user of the vehicle by using the display; the display can be a central interactive display and can also be used for an infotainment system of the vehicle; the vehicle-integrated computer can operate the infotainment system of the vehicle; the vehicle-integrated computer can be disposed completely between the front storage area and the dashboard area; and the compartment can comprise at least one transparent upper portion such that the vehicle-integrated computer is visible, through the at least one transparent portion, from an outside of the vehicle. The at least one light can be configured to: turn on for a flash of one second or less when the user of the vehicle uses the display to select that the light should flash; and turn on until turned off when the user of the vehicle uses the display to select that the light should be turned on. The display can have an area of, for example, at least 25 square inches.

### BRIEF DESCRIPTION OF DRAWINGS

FIG. 1 shows a schematic view of a system for observing and/or monitoring a second row in a vehicle, according to an embodiment of the subject invention.

FIG. 2 shows a block diagram of a system for observing and/or monitoring a second row in a vehicle, according to an embodiment of the subject invention.

FIG. 3 shows a schematic view of a system for observing and/or monitoring a second row in a vehicle, according to an embodiment of the subject invention.

### DETAILED DESCRIPTION

Embodiments of the subject invention provide novel and advantageous systems and methods for viewing, observing, and/or monitoring a second row (of seats) in a vehicle. A camera can be provided in the second row of seats, near the rear of the vehicle, and can be forward-facing or generally forward-facing. The camera can provide a live video feed (and/or still images) to a display in the vehicle, such as a display on the instrument panel in the front row of the vehicle. Such a display is easily viewable by a driver and/or a passenger in the front row. The live video feed (and/or still images) from the camera can be of the second row of seats. This can enable a driver and/or a passenger in the front row to easily and conveniently observe and/or monitor the second row of seats without having to turn around and without the need for any mirror (attached to the front windshield or positioned on the rear seat headrest). For example, a driver and/or a passenger in the front row can easily and conveniently observe and/or monitor a child in a rear-facing child seat in the second row of seats. The system can allow such observation and/or monitoring whether the vehicle is stationary or in motion.

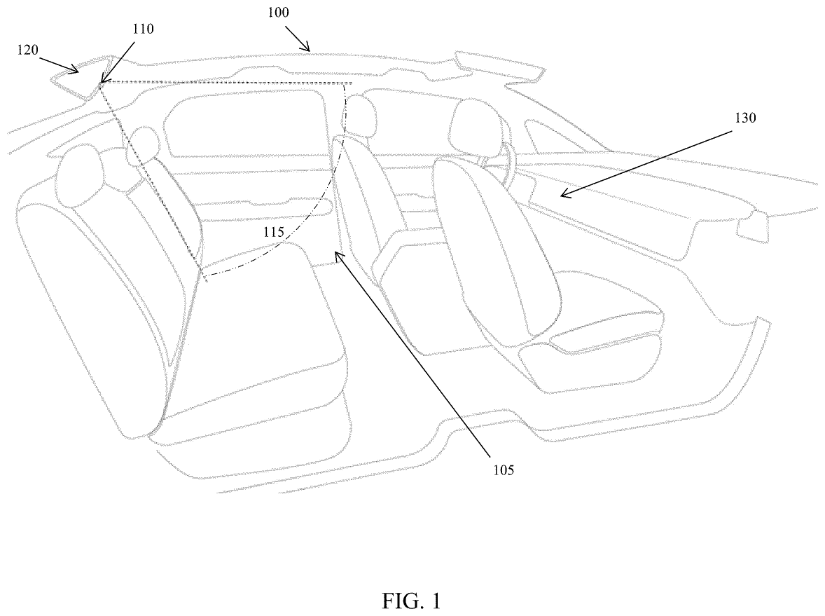

FIG. 1 shows a schematic view of a system for observing and/or monitoring a second row in a vehicle, according to an embodiment of the subject invention. Referring to FIG. 1, a camera 110 can be disposed (e.g., mounted) in the rear area in the interior of a vehicle 100. For example, the camera 110 can be mounted on a rear header 120, which is the cross-car overhead structure that is behind where rear occupants would be in the vehicle 100, though embodiments are not limited thereto. The camera can also be disposed on, for example, the ceiling or the rear windshield. The camera 110 can be facing or directed in a forward or generally forward direction (i.e., facing the vehicle's interior, generally towards the back of the front seats). The camera 110 can provide a live video feed (and/or still images) to a display 130. The display 130 can be positioned on the instrument panel where it is easily viewable by a driver and/or front-row passenger of the vehicle 100. The live video feed (and/or still images) provided by the camera 110 can be of the second-row seat area 105 of the vehicle 100. The field of view 115 of the camera 110 depicted in FIG. 1 is for exemplary purposes only and should not be construed as limiting. The field of view 115 has a cone shape and can in certain embodiments be adjusted to be larger or smaller as desired.

The camera direction can be alterable, such that it can be moved (e.g., via controls on the display 130 and/or via a remote controller (not pictured), such as a key fob or other remote controller; the remote controller can be in operable communication with the camera by a wired or wireless connection). The camera direction can be alterable, such that it can be moved left, right, up, or down as desired. For example, a user (e.g., a driver or a front-row passenger) may want a more focused view of the left second-row seat, such as if a child is positioned in a rear-facing child seat in the left second-row seat. The field of view 115 may also be expanded for a view of the entire second-row seat area 105 of the vehicle 100, which would be less focused than a view of only the left, only the center, or only the right seat of the second row area 105. The camera can include one or more lights (e.g., light-emitting diodes (LEDs), though embodiments are not limited thereto) that can be used to light up the second-row seat area 105 (e.g., for a flash (e.g., less than a second or even less than 0.5 seconds) or for a more sustained period of time). The one or more lights can be used, for example, when it is dark outside. For example, a user (e.g., a driver or front-row passenger) may want to observe and/or monitor a child in a rear-facing child seat in the second row and may command the camera to turn on the one or more lights for a flash (e.g., if it is suspected the child is asleep) or for a more sustained period of time.

The display 130 can be configured such that it does not always display the feed from the camera. Instead, a user (e.g., a driver or a front-row passenger) can select on option on the display such that it displays the feed from the camera. This option can also be deselected such that the display switches to displaying something else (e.g., something from an infotainment system of the vehicle.

The display 130 can be a large display, such as a display with an area of, for example, any of the following values, at least any of the following values, about any of the following values, no more than any of the following values, or within any range having any of the following values as endpoints (all values are in square inches (in²)): 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 70, 75, 80, 81, 85, 90, 95, 100, 110, 120, 130, 140, 144, 150, 160, 170, 180, 190, or 200. For example, the display can have an area of at least 25 in².

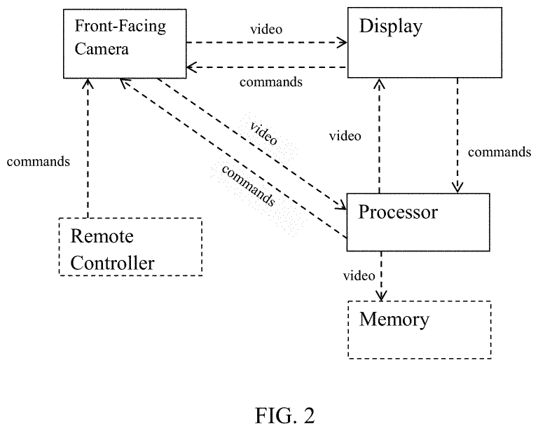

FIG. 2 shows a block diagram of a system for observing and/or monitoring a second row in a vehicle, according to an embodiment of the subject invention. Referring to FIG. 2, the front-facing (or generally front-facing) camera can communicate directly with the display, sending video thereto and/or receiving commands (e.g., move the camera direction, adjust the field of view, turn off the camera when not in use, turn the camera light(s) on or off, or even switch from live feed to capturing a still image) from the display. The system can optionally include a remote controller that can provide commands to the camera (e.g., move the camera direction, adjust the field of view, turn off the camera when not in use, turn the camera light(s) on or off, or even switch from live feed to capturing a still image) either in addition to or instead of the display, if the remote controller is present. The camera can also communicate with a processor (separate from the display) in the vehicle, providing video thereto and/or receiving commands therefrom. The processor can be part of a computer (e.g., a vehicle-integrated computer) of the vehicle and/or can be part of a system of the vehicle (e.g., an infotainment system or other system). The processor can provide video to the display, either as received or processed (e.g., cleaned up, and/or after being saved to an optional memory in operable communication with the processor (such as a memory of a vehicle-integrated computer having the processor)). The processor can receive commands entered via the display and provide them to the camera and/or the processor can provide commands directly to the camera (e.g., commands programmed previously by a user).

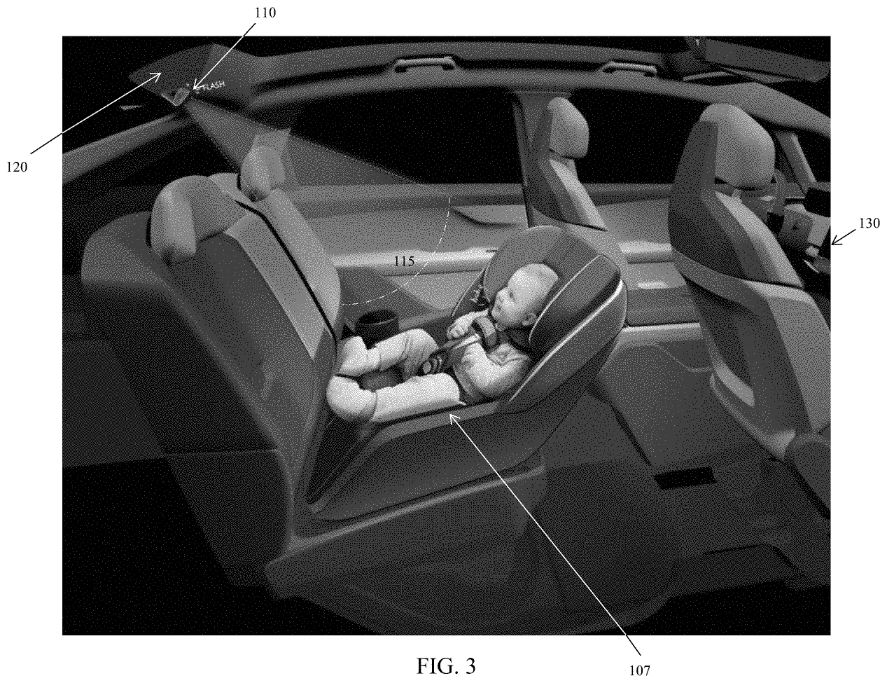

FIG. 3 shows a schematic view of a system for observing and/or monitoring a second row in a vehicle, according to an embodiment of the subject invention. Referring to FIG. 3, the camera 110 can be directed to an occupant 107 of the second-row area of seats, such as a child or baby in a rear-facing child seat. FIG. 3 also indicates that the one or more lights on the camera 110 is activate (using the term “flash” in the figure), showing how the occupant 107 can be illuminated when it is dark outside, thereby providing a viewable live feed (and/or still image(s)) to the display 130, a small portion of which can be seen at the edge of FIG. 3. In the instance depicted in FIG. 3, the field of view 115 has been narrowed some to focus on the single occupant 107 and, though it cannot be easily determined from FIG. 3, the camera 110 has been directed to face the right seat of the second-row seat area.

In many embodiments, the display 130 can be a central interactive display (CID), and the display may also be used for an infotainment (entertainment and information) system of the vehicle. The display 130, infotainment system (if present), and/or camera 110 can be in operable communication with a vehicle-integrated computer disposed within the vehicle, such as the vehicle-integrated computer described in U.S. Pat. No. 10,675,977, which is hereby incorporated by reference herein in its entirety. The vehicle-integrated computer (if present) can be used for the infotainment system (if present). In certain embodiments, the vehicle 100 can comprise a front storage area forward of a dashboard area (e.g., a dashboard area having the instrument panel) of the vehicle 100, and the vehicle-integrated computer (if present) can be disposed in a compartment adjacent to or contained in the front storage area. At least a portion of the compartment can be disposed between the front storage area and the dashboard area (e.g., the vehicle-integrated computer (if present) can be disposed completely between the front storage area and the dashboard area). The compartment can comprise at least one transparent upper portion (e.g., made of glass or a transparent polymer), functioning as a window through a front hood of the vehicle so an external viewer can see the vehicle-integrated computer (if present). That is, the vehicle-integrated computer (if present) can be disposed where a car engine would typically be disposed in an internal combustion engine powered vehicle (e.g., under a front hood), and it the front hood may include at least one transparent upper portion functioning as a window above the vehicle-integrated computer (if present).

The vehicle 100 having the camera 110 and the display 130 can be any suitable type of roadworthy vehicle (e.g., a car, truck, motorcycle). The vehicle can be an electric vehicle, though embodiments are not limited thereto.

Though the systems and methods of embodiments of the subject invention have been described herein with respect to one camera, it is possible to include two or more front-facing cameras (e.g., one facing the right seat of the second row, one facing the left seat of the second row and/or one facing the center seat of the second row) instead. The rest of the system would function as described herein.

Systems and methods of embodiments of the subject invention can utilize hardware in a vehicle (e.g., a video camera and a large display) to allow a driver and/or front passenger to clearly and easily monitor a second row of the vehicle (e.g., to monitor a child in a rear-facing child seat). Without this technology, such monitoring is difficult and must generally be done with the assistance of mirrors. Systems and methods of embodiments of the subject invention can enable a user (e.g., a driver and/or front passenger) to quickly assess the second row (e.g., the status of a child in a rear-facing child seat).

The methods, systems, and processes described herein can be embodied as code and/or data. The software code and data described herein can be stored on one or more machine-readable media (e.g., computer-readable media), which may include any device or medium that can store code and/or data for use by a computer system. When a computer system and/or processor reads and executes the code and/or data stored on a computer-readable medium, the computer system and/or processor performs the methods and processes embodied as data structures and code stored within the computer-readable storage medium.

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed that is capable of storing computer-readable information/data. Computer-readable media should not be construed or interpreted to include any propagating signals (i.e., computer-readable media can be referred to as non-transitory). A computer-readable medium of the subject invention can be, for example, a compact disc (CD), digital video disc (DVD), flash memory device, volatile memory, or a hard disk drive (HDD), such as an external HDD or the HDD of a computing device, though embodiments are not limited thereto. A computing device can be, for example, a laptop computer, desktop computer, server, cell phone, or tablet, though embodiments are not limited thereto.

The subject invention includes, but is not limited to, the following exemplified embodiments.

Embodiment 1. A system for viewing, observing, and/or monitoring a second row (of seats) in a vehicle, the system comprising:

a camera disposed in and/or above a second row of a vehicle having a front row and the second row, the camera facing towards the front row of the vehicle; and

a display disposed in the front row of the vehicle and in operable communication with the camera (such that the display is configured to display (and/or actually displays) a live video feed (of the second row) from the camera when in use).

Embodiment 2. The system according to embodiment 1, wherein the vehicle is a roadworthy vehicle.

Embodiment 3. The system according to any of embodiments 1-2, wherein the vehicle is an electric vehicle.

Embodiment 4. The system according to any of embodiments 1-3, further comprising: at least one light disposed on or near the camera (and configured to provide (and/or actually providing) light to the second row of the vehicle when in use).

Embodiment 5. The system according to embodiment 4, wherein the at least one light comprises a light emitting diode (LED).

Embodiment 6. The system according to any of embodiments 4-5, wherein the at least one light is configured to provide (and/or actually provides) light to the second row of the vehicle in: a) a flash of one second or less (e.g., from a time when a user indicates the light should be flashed); b) an extended period of time (e.g., from when a user indicates the light should be turned on until the user indicates the light should be turned off); or c) both.

Embodiment 7. The system according to any of embodiments 1-6, wherein the display is configured to display (and/or actually displays): a live video feed from the camera when in use (and a live video option is selected by a user); and a still image from the camera when in use (and a still image option is selected by a user).

Embodiment 8. The system according to any of embodiments 1-7, wherein the camera is mounted on a rear header of the vehicle.

Embodiment 9. The system according to any of embodiments 1-7, wherein the camera is disposed on a ceiling of the vehicle.

Embodiment 10. The system according to any of embodiments 1-7, wherein the camera is disposed on a rear window of the vehicle.

Embodiment 11. The system according to any of embodiments 1-10, wherein the display is disposed on an instrument panel of the vehicle.

Embodiment 12. The system according to any of embodiments 1-11, wherein a direction in which the camera is pointed is alterable by a user of the system.

Embodiment 13. The system according to embodiment 12, wherein the direction in which the camera is pointed is alterable by using the display.

Embodiment 14. The system according to any of embodiments 12-13, wherein the direction in which the camera is pointed is alterable by using a remote controller in operable communication with the camera.

Embodiment 15. The system according to any of embodiments 1-14, wherein a field of view of the camera is alterable by a user of the system.

Embodiment 16. The system according to embodiment 15, wherein the field of view of the camera is alterable by using the display.

Embodiment 17. The system according to any of embodiments 15-16, the field of view of the camera is alterable by using a remote controller in operable communication with the camera.

Embodiment 18. The system according to any of embodiments 1-17, wherein the display is a central interactive display.

Embodiment 19. The system according to any of embodiments 1-18, wherein the display is also used for an infotainment system of the vehicle.

Embodiment 20. The system according to any of embodiments 1-19, wherein the camera and the display are in operable communication with a processor (e.g., a processor of a vehicle-integrated computer) of the vehicle, wherein the processor is separate from the display.

Embodiment 21. The system according to embodiment 20, wherein the processor receives video from the camera and transmits video to the display.

Embodiment 22. The system according to embodiment 21, wherein the processor first processes (cleans up, and/or saves to an optional memory in operable communication with the processor) the video before transmitting it to the display.

Embodiment 23. The system according to any of embodiments 20-22, wherein the processor transmits commands (e.g., move the camera direction, adjust the field of view, turn off the camera when not in use, turn the camera light(s) on or off, switch from live feed to capturing a still image) to the camera.

Embodiment 24. The system according to embodiment 23, wherein the processor receives the commands from the display before transmitting them to the camera.

Embodiment 25. The system according to any of embodiments 1-24, wherein the camera and the display are in operable communication with a vehicle-integrated computer of the vehicle.

Embodiment 26. The system according to embodiment 25, wherein the vehicle-integrated computer operates an infotainment system of the vehicle.

Embodiment 27. A vehicle, comprising:

a front row;

a second row behind the front row;

a camera disposed in and/or above the second row of the vehicle and facing towards the front row of the vehicle; and

a display disposed in the front row of the vehicle and in operable communication with the camera (such that the display is configured to display (and/or actually displays) a live video feed (of the second row) from the camera when in use).

Embodiment 28. The vehicle according to embodiment 27, wherein the vehicle is a roadworthy vehicle.

Embodiment 29. The vehicle according to any of embodiments 27-28, wherein the vehicle is an electric vehicle.

Embodiment 30. The vehicle according to any of embodiments 27-29, further comprising at least one light disposed on or near the camera (and configured to provide (and/or actually providing) light to the second row of the vehicle when in use).

Embodiment 31. The vehicle according to embodiment 30, wherein the at least one light comprises a light emitting diode (LED).

Embodiment 32. The vehicle according to any of embodiments 30-31, wherein the at least one light is configured to provide (and/or actually provides) light to the second row of the vehicle in: a) a flash of one second or less (e.g., from a time when a user indicates the light should be flashed); b) an extended period of time (e.g., from when a user indicates the light should be turned on until the user indicates the light should be turned off); or c) both.

Embodiment 33. The vehicle according to any of embodiments 27-32, wherein the display is configured to display (and/or actually displays): a live video feed from the camera when in use (and a live video option is selected by a user); and a still image from the camera when in use (and a still image option is selected by a user).

Embodiment 34. The vehicle according to any of embodiments 27-33, wherein the camera is mounted on a rear header of the vehicle.

Embodiment 35. The vehicle according to any of embodiments 27-33, wherein the camera is disposed on a ceiling of the vehicle.

Embodiment 36. The vehicle according to any of embodiments 27-33, wherein the camera is disposed on a rear window of the vehicle.

Embodiment 37. The vehicle according to any of embodiments 27-36, wherein the display is disposed on an instrument panel of the vehicle.

Embodiment 38. The vehicle according to any of embodiments 27-37, wherein a direction in which the camera is pointed is alterable by a user of the vehicle.

Embodiment 39. The vehicle according to embodiment 38, wherein the direction in which the camera is pointed is alterable by using the display.

Embodiment 40. The vehicle according to any of embodiments 38-39, wherein the direction in which the camera is pointed is alterable by using a remote controller in operable communication with the camera.

Embodiment 41. The vehicle according to any of embodiments 27-40, wherein a field of view of the camera is alterable by a user of the vehicle.

Embodiment 42. The vehicle according to embodiment 41, wherein the field of view of the camera is alterable by using the display.

Embodiment 43. The vehicle according to any of embodiments 41-42, the field of view of the camera is alterable by using a remote controller in operable communication with the camera.

Embodiment 44. The vehicle according to any of embodiments 27-43, wherein the display is a central interactive display.

Embodiment 45. The vehicle according to any of embodiments 27-44, wherein the display is also used for an infotainment system of the vehicle.

Embodiment 46. The vehicle according to any of embodiments 27-45, further comprising a processor separate from the display (e.g., a processor of a vehicle-integrated computer), wherein the camera and the display are in operable communication with the processor.

Embodiment 47. The vehicle according to embodiment 46, wherein the processor receives video from the camera and transmits video to the display.

Embodiment 48. The vehicle according to embodiment 47, wherein the processor first processes (cleans up, and/or saves to an optional memory in operable communication with the processor) the video before transmitting it to the display.

Embodiment 49. The vehicle according to any of embodiments 46-48, wherein the processor transmits commands (e.g., move the camera direction, adjust the field of view, turn off the camera when not in use, turn the camera light(s) on or off, switch from live feed to capturing a still image) to the camera.

Embodiment 50. The vehicle according to embodiment 49, wherein the processor receives the commands from the display before transmitting them to the camera.

Embodiment 51. The vehicle according to any of embodiments 27-50, further comprising a vehicle-integrated computer, wherein the camera and the display are in operable communication with the vehicle-integrated computer.

Embodiment 52. The vehicle according to embodiment 51, wherein the vehicle-integrated computer operates an infotainment system of the vehicle.

Embodiment 53. The vehicle according to any of embodiments 51-52, further comprising a dashboard area and a front storage area forward of the dashboard area.

Embodiment 54. The vehicle according to embodiment 53, further comprising a compartment adjacent to (or contained in) the front storage area, wherein the vehicle-integrated computer is disposed in the compartment.

Embodiment 55. The vehicle according to embodiment 54, wherein at least a portion of the compartment is disposed between the front storage area and the dashboard area.

Embodiment 56. The vehicle according to any of embodiments 53-55, wherein the vehicle-integrated computer is disposed completely between the front storage area and the dashboard area.

Embodiment 57. The vehicle according to any of embodiments 54-56, wherein the compartment comprises at least one transparent upper portion (e.g., made of glass or a transparent polymer, and functioning as a window through a front hood of the vehicle so an external viewer can see the vehicle-integrated computer).

Embodiment 58. A method for viewing, observing, and/or monitoring a second row (of seats) in a vehicle, the method comprising:

providing the system according to any of embodiments 1-26 or the vehicle comprising any of embodiments 27-57; and utilizing the camera to view, observe, and/or monitor the second row on the display.

Embodiment 59. The system according to any of embodiments 1-26, the vehicle comprising any of embodiments 27-57, or the method according to embodiment 58, wherein the display has an area of at least 25 in².

Embodiment 60. The system, vehicle, or method according to embodiment 59, wherein the display has an area of at least 36 in².

Embodiment 61. The system, vehicle, or method according to embodiment 59, wherein the display has an area of at least 49 in².

Embodiment 62. The system, vehicle, or method according to embodiment 59, wherein the display has an area of at least 64 in².

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

What is claimed is:

1. A vehicle, comprising:
a front row;
a second row behind the front row;
a camera disposed in or above the second row of the vehicle and facing towards the front row of the vehicle; and
a display disposed in the front row of the vehicle and in operable communication with the camera, the display being configured to display a live video feed of the second row from the camera when in use,
wherein the vehicle is a roadworthy vehicle.

2. The vehicle according to claim 1, wherein the vehicle is an electric vehicle.

3. The vehicle according to claim 1, further comprising at least one light disposed on or adjacent the camera, the at least one light being configured to provide light to the second row when in use.

4. The vehicle according to claim 1, wherein the camera is mounted on a rear header of the vehicle.

5. The vehicle according to claim 1, wherein the display is disposed on an instrument panel of the vehicle.

6. The vehicle according to claim 1, wherein a direction in which the camera is pointed is alterable by a user of the vehicle by using the display.

7. The vehicle according to claim 1, wherein a field of view of the camera is alterable by a user of the vehicle by using the display.

8. The vehicle according to claim 1, wherein the display is a central interactive display and is also used for an infotainment system of the vehicle.

9. The vehicle according to claim 1, further comprising a vehicle-integrated computer, wherein the camera and the display are in operable communication with the vehicle-integrated computer.

10. The vehicle according to claim 9, wherein the vehicle-integrated computer operates an infotainment system of the vehicle.

11. The vehicle according to claim 9, further comprising:
a dashboard area;
a front storage area forward of the dashboard area; and
a compartment adjacent to or contained in the front storage area,
wherein the vehicle-integrated computer is disposed in the compartment.

12. A system for viewing a second row in a roadworthy vehicle, the system comprising:
a camera disposed in or above the second row of the vehicle having a front row and the second row, the camera facing towards the front row of the vehicle; and
a display disposed in the front row of the vehicle and in operable communication with the camera, the display being configured to display a live video feed of the second row from the camera when in use.

13. The system according to claim 12, wherein the vehicle is an electric vehicle.

14. The system according to claim 12, further comprising at least one light disposed on or adjacent the camera, the at least one light being configured to provide light to the second row when in use.

15. The system according to claim 12, wherein the camera is mounted on a rear header of the vehicle.

16. The system according to claim 12, wherein the display is disposed on an instrument panel of the vehicle.

17. The system according to claim 12, wherein a direction in which the camera is pointed is alterable by a user of the system by using the display.

18. The system according to claim 12, wherein a field of view of the camera is alterable by a user of the system by using the display.

19. The system according to claim 12, wherein the display is a central interactive display,
wherein the display is also used for an infotainment system of the vehicle,
wherein the camera and the display are in operable communication with a vehicle-integrated computer of the vehicle, and
wherein the vehicle-integrated computer operates the infotainment system of the vehicle.

20. A vehicle, comprising:
a front row;
a second row behind the front row;
a camera disposed in or above the second row of the vehicle and facing towards the front row of the vehicle;
a display disposed in the front row of the vehicle and in operable communication with the camera, the display being configured to display a live video feed of the second row from the camera when in use;
at least one light disposed on or adjacent the camera, the at least one light being configured to provide light to the second row when in use;
a vehicle-integrated computer, wherein the camera and the display are in operable communication with the vehicle-integrated computer;
a dashboard area;
a front storage area forward of the dashboard area; and
a compartment adjacent to or contained in the front storage area,
wherein the vehicle is a roadworthy vehicle,
wherein the vehicle is an electric vehicle,
wherein the vehicle-integrated computer is disposed in the compartment,
wherein the camera is mounted on a rear header of the vehicle,
wherein the display is disposed on an instrument panel of the vehicle, which is located at the dashboard area of the vehicle,
wherein a direction in which the camera is pointed is alterable by a user of the vehicle by using the display,
wherein a field of view of the camera is alterable by the user of the vehicle by using the display,
wherein the display is a central interactive display and is also used for an infotainment system of the vehicle,
wherein the vehicle-integrated computer operates the infotainment system of the vehicle,
wherein the at least one light is configured to: turn on for a flash of one second or less when the user of the vehicle uses the display to select that the light should flash; and turn on until turned off when the user of the vehicle uses the display to select that the light should be turned on,
wherein the vehicle-integrated computer is disposed completely between the front storage area and the dashboard area,
wherein the compartment comprises at least one transparent upper portion such that the vehicle-integrated computer is visible, through the at least one transparent portion, from an outside of the vehicle, and
wherein the display has an area of at least 25 square inches.
